(19) United States
(12) Patent Application Publication
(10) Pub. No.: US 2015/0322987 A1
(43) Pub. Date: Nov. 12, 2015

(54) CABLE TRAY SEGMENTS WITH INTEGRATED SPLICE PLATES

(71) Applicant: Pedro Rivera Romano, Mexico City (MX)

(72) Inventor: Pedro Rivera Romano, Mexico City (MX)

(21) Appl. No.: 14/272,350

(22) Filed: May 7, 2014

(51) Int. Cl. F16B 7/18; F16L 3/26

(52) U.S. Cl. CPC F16B 7/182; F16L 3/26

(57) ABSTRACT

A cable tray segment is described herein. The cable tray segment can include a first rail substantially parallel to a second rail. The first rail can have a length and include a first coupling portion disposed at a first distal end of the first rail, where the first coupling portion protrudes from the first rail by a distance, and where the first coupling portion includes at least one first coupling feature. The first rail can also include a second coupling portion disposed at a first proximal end of the first rail, where the second coupling portion includes at least one first complementary coupling feature. The second rail can be disposed substantially parallel to the first rail and have the first length. The second rail can be substantially similar to the first rail.

### TECHNICAL FIELD

The present disclosure relates generally to cable trays and more particularly to systems, methods, and devices for cable tray segments with integral splice plates.

### BACKGROUND

In a number of commercial and industrial applications, electrical cable is used to provide power from a power source to one or more electrical loads. The electrical cable can be run (laid out along a path) in one or more ways. In some cases, one or more electrical cables are disposed within conduit. In some cases, one or more electrical cables are put in a cable tray system. A cable tray system often includes multiple cable tray segments that are assembled end-to-end. Assembling cable tray segments to each other can be a time-consuming task.

### SUMMARY

In general, in one aspect, the disclosure relates to a cable tray segment having a first side rail and a second side rail. The first side rail can have a length and can include a first coupling portion disposed at a first distal end of the first side rail, where the first coupling portion protrudes from the first side rail by a distance, and where the first coupling portion has at least one first coupling feature. The first side rail can also include a second coupling portion disposed at a first proximal end of the first side rail, where the second coupling portion has at least one first complementary coupling feature. The second side rail can have the length and can be disposed substantially parallel to the first side rail. The second side rail can include a third coupling portion disposed at a second distal end of the second side rail, where the first coupling portion protrudes from the first side rail by the distance, and where the third coupling portion has at least one second coupling feature. The second side rail can also include a fourth coupling portion disposed at a second proximal end of the second side rail, where the fourth coupling portion has at least one second complementary coupling feature. The at least one first coupling feature can be configured to mechanically couple to the first complementary coupling feature of a first other cable tray segment. The at least one first complementary coupling feature can be configured to mechanically couple to the first coupling feature of a second other cable tray segment. The at least one second coupling feature can be configured to mechanically couple to the second complementary coupling feature of the first other cable tray segment. The at least one second complementary coupling feature can be configured to mechanically couple to the second coupling feature of the second other cable tray segment.

In another aspect, the disclosure can generally relate to a cable tray system. The cable tray system can include a first cable tray segment having a first side rail having a length and a second side rail having the length, where the first side rail and the second side rail each has a first coupling portion disposed at a first distal end, where each first coupling portion protrudes from the first side rail and the second side rail by a distance, where each first coupling portion has at least one first coupling feature. The cable tray system can also include a second cable tray segment having a third side rail having the length and a fourth side rail having the length, where the third side rail and the fourth side rail each has a second coupling portion disposed at a second proximal end, where each second coupling portion has at least one first complementary coupling feature. The cable tray system can further include at least one crossbar disposed between and coupled to the first side rail and the second side rail. The at least one first coupling feature can couple to the at least one first complementary coupling feature.

In yet another aspect, the disclosure can generally relate to a cable system. The cable system can include a first cable tray segment having a first side rail having a length and a second side rail having the length, where the first side rail and the second side rail each has a first coupling portion disposed at a first distal end, where each of the first coupling portions protrudes from the first side rail and the second side rail by a distance, where each first coupling portion has at least one first coupling feature. The cable system can also include a second cable tray segment, comprising a third side rail having the length and a fourth side rail having the length, where the third side rail and the fourth side rail each has a second coupling portion disposed at a second proximal end, where each second coupling portion has at least one first complementary coupling feature. The cable system can further include at least one fastening device coupled to the at least one first coupling feature of the first cable tray segment and the at least one first complementary coupling feature of the second cable tray segment. The cable system can also include a number of crossbars disposed between and coupled to the first side rail and the second side rail. The cable system can further include at least one cable disposed on the crossbars.

These and other aspects, objects, features, and embodiments will be apparent from the following description and the appended claims.

### BRIEF DESCRIPTION OF THE DRAWINGS

The drawings illustrate only example embodiments and are therefore not to be considered limiting of its scope, as the example embodiments may admit to other equally effective embodiments. The elements and features shown in the drawings are not necessarily to scale, emphasis instead being placed upon clearly illustrating the principles of the example embodiments. Additionally, certain dimensions or positionings may be exaggerated to help visually convey such principles. In the drawings, reference numerals designate like or corresponding, but not necessarily identical, elements.

FIGS. 1A and 1B shows various views of adjacent cable tray segments currently known in the art.

FIGS. 2A-2C show various views of adjacent cable tray segments in accordance with certain example embodiments.

FIG. 3 shows a detailed view of coupling features of adjacent cable tray segments in accordance with certain example embodiments.

FIG. 4 shows a detailed view of coupling portions of adjacent cable tray segments in accordance with certain example embodiments.

FIG. 5 shows a detailed view of alternative coupling portions of adjacent cable tray segments in accordance with certain example embodiments.

FIG. 6 shows a detailed view of other alternative coupling portions of adjacent cable tray segments in accordance with certain example embodiments.

FIG. 7 shows a detailed view of still other alternative coupling portions of adjacent cable tray segments in accordance with certain example embodiments.

### DETAILED DESCRIPTION OF EXAMPLE EMBODIMENTS

The example embodiments discussed herein are directed to systems, apparatuses, and methods of cable tray segments with integrated splice plates. While the example cable tray segments with integrated splice plates shown in the Figures and described herein are supporting electrical cable, example cable tray segments with integrated splice plates can also be used to support other types of cable, including but not limited to pipe (including conduit inside of which a cable is disposed) and mechanical cable. Thus, the examples of cable tray segments with integrated splice plates described herein are not limited to conduit for electrical cables.

As defined herein, electrical cable can be used to conduct power (e.g., high voltage) and/or control (e.g., low voltage) signals. Power flowing through an electrical cable can be alternating current or direct current. Each electrical cable can carry voltage and/or current from one end of the electrical cable to the other end. Each electrical cable can have one or more electrical conductors disposed therein. In some cases, an electrical cable can include a ground or neutral conductor, through which no (or negligible) current or voltage flows. Each electrical conductor within an electrical cable may be of any suitable size (e.g., 12 American Wire Gauge (AWG)) and made of one or more of a number of materials (e.g., copper, aluminum). Each electrical cable may be coated with an insulator made of any suitable material (e.g., rubber, plastic) to keep the electrical conductors electrically isolated from any other conductor in the electrical cable.

The cable tray segments with integrated splice plates described herein can be physically placed in outdoor environments. In addition, or in the alternative, example cable tray segments with integrated splice plates can be subject to extreme heat, extreme cold, moisture, humidity, high winds, dust, chemical corrosion, and other conditions that can cause wear on the cable tray segments with integrated splice plates or portions thereof. In certain example embodiments, the cable tray segments with integrated splice plates, including any portions thereof, are made of materials that are designed to maintain a long-term useful life and to perform when required without mechanical failure. Such materials can include, but are not limited to, stainless steel and aluminum.

Cable tray systems are often suspended from a ceiling or other portion of a structure. In such a case, a number of supports are used to suspend the cable tray system (or a portion thereof) by coupling to a cable tray segment of the cable tray system (sometimes with the aid of a strut channel) at one end of the support and to the ceiling or other portion of the structure at the other end of the support. In one or more example embodiments, a user is any person that interacts with cable trays. For example, a user may be, but is not limited to, a maintenance worker, an electrician, a contractor, an engineer, a supervisor, a home owner, a business owner, and a company representative.

A cable tray system, whether using one or more example cable tray segments or not, may have to comply with one or more of a number of electrical and/or mechanical standards. For example, the National Electrical Manufacturers Association (NEMA) has created and maintains one or more standards related to cable tray systems. As a specific example, NEMA VE 1-2009 lists specific requirements for metal cable trays and associated fittings. As another specific example, NEMA classifies cable trays by load designation. For instance, a NEMA 8A cable tray is capable of supporting a working load (e.g., one or more electrical cables) of at least 50 pounds per foot with cable tray supports for the cable tray spaced every 8 feet, while a NEMA 20C cable tray is capable of supporting a working load (e.g., one or more electrical cables) of at least 100 pounds per foot with cable tray supports for the cable tray spaced every 20 feet. Cable tray systems using example cable tray segments can meet any NEMA cable tray classification.

Examples of other entities that have standards associated with cable tray systems is the National Electric Code (NEC), the Canadian Electric Code (CEC), the Canadian Standards Association (CSA), Underwriters Laboratories (UL), and the International Electrotechnical Commission (IEC). Example cable tray segments described herein can allow such cable tray systems to comply with such standards.

Components and/or features described herein can include elements that are described as coupling, fastening, securing, or other similar terms. Such terms are merely meant to distinguish various elements and/or features within a component or device and are not meant to limit the capability or function of that particular element and/or feature. For example, a feature described as a “coupling feature” can secure, fasten, align, and/or perform other functions aside from merely coupling.

A coupling feature (including a complementary coupling feature) as described herein can allow one or more components and/or portions of an example cable tray segment to become mechanically coupled, directly or indirectly, to a portion of another example cable tray segment. A coupling feature can include, but is not limited to, a portion of a hinge, an aperture, a recessed area, a protrusion, a slot, a spring clip, a tab, a detent, and mating threads. One portion of an example cable tray segment can be coupled to a portion of another cable tray segment by the direct use of one or more coupling features.

In addition, or in the alternative, a portion of an example cable tray segment can be coupled to a portion of another cable tray segment using one or more independent devices that interact with one or more coupling features disposed on a component of the example cable tray segment. Examples of such devices can include, but are not limited to, a pin, a hinge, a fastening device (e.g., a bolt, a screw, a rivet), and a spring. One coupling feature described herein can be the same as, or different than, one or more other coupling features described herein. A complementary coupling feature as described herein can be a coupling feature that mechanically couples, directly or indirectly, with another coupling feature.

Any component described in one or more figures herein can apply to any subsequent figures having the same label. In other words, the description for any component of a subsequent (or other) figure can be considered substantially the same as the corresponding component described with respect to a previous (or other) figure. Further, if a component associated with a figure is described but not expressly shown or labeled in the figure, a corresponding component shown and/or labeled in another figure can be inferred. The numbering scheme for the components in the figures herein parallel the numbering scheme for the components of previously or subsequently described figures in that each component is a three digit number having the identical last two digits.

Example embodiments of cable tray segments with integrated splice plates will be described more fully hereinafter with reference to the accompanying drawings, in which example embodiments of cable tray segments with integrated splice plates are shown. Cable tray segments with integrated splice plates may, however, be embodied in many different forms and should not be construed as limited to the example embodiments set forth herein. Rather, these example embodiments are provided so that this disclosure will be thorough and complete, and will fully convey the scope of cable tray segments with integrated splice plates to those of ordinary skill in the art. Like, but not necessarily the same, elements (also sometimes called components) in the various figures are denoted by like reference numerals for consistency. Terms such as “first,” “second,” “distal,” “proximal,” “top,” and “bottom” are used merely to distinguish one component (or part of a component) from another. Such terms are not meant to denote a preference or a particular orientation.

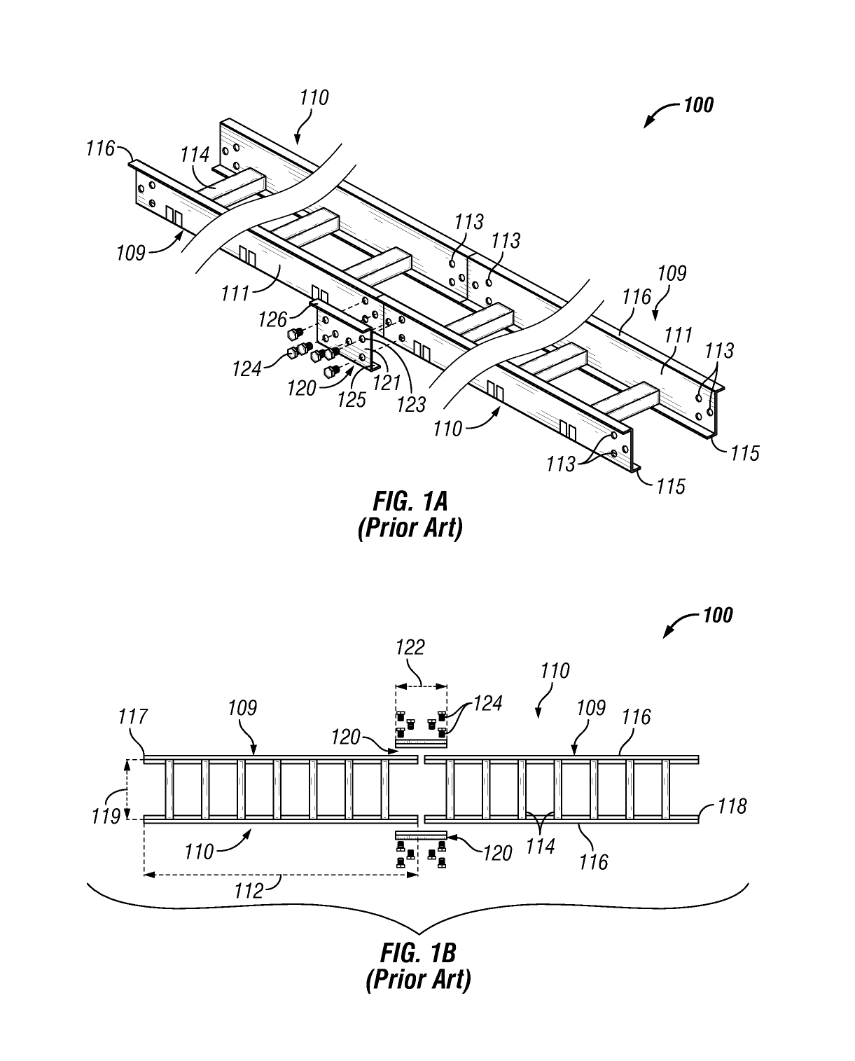

FIGS. 1A and 1B shows various views of a cable tray system 100 of adjacent cable tray segments 110 currently known in the art. Specifically, FIG. 1A shows a top-side perspective view of the system 100, and FIG. 1B shows a top view of the system 100. Referring to FIGS. 1A and 1B, the cable tray system 100 includes two adjacent cable tray segments 110 that are substantially identical to each other. The system 100 also includes two splice plates 120, and a number of bolts 124. Each cable tray segment 110 has two rails 109 (also called side rails 109), where each rail 109 has a length 112 and is substantially parallel to the other rail 109 of the cable tray segment 110. A number of cable supports 114 (also called crossbars 114), each having a length 119, are disposed between and mechanically coupled to the two rails 109, giving each cable tray segment 110 a width that is substantially the same as the length 119 of the crossbars 114.

Each rail 109 can have one or more of a number of features. For example, as shown in FIGS. 1A and 1B, a rail 109 has a “Z” shape when viewed cross-sectionally along its length 112. Specifically, the rail 109 can have a body 111 that forms a substantially straight (flat) vertical line when viewed cross-sectionally along its length 112. The rails 109 of FIGS. 1A and 1B also have a top flange 116 and a bottom flange 115, where the top flange 116 extends substantially perpendicularly outward from the top end of the body 111, and where the bottom flange 115 extends substantially perpendicularly inward from the bottom end of the body 111.

Each rail 109 also includes multiple apertures 113. The apertures 113 traverse the body 111 at both ends (the proximal end 117 and the distal end 118) of the rail 109. Typically, as in this case, there are three apertures 113 at the proximal end 117 of the rail 109 and another three apertures 113 at the distal end 118 of the rail 109. The apertures 113 have a sufficient shape and size to accommodate the bolts 124. Also, the apertures 113 are oriented in a particular way.

Each splice plate 120 has a length 122 that is substantially shorter than the length 122 of a rail 109. Otherwise, as shown in FIGS. 1A and 1B, the splice plate 120 can have substantially the same dimensions (e.g., height, thickness) and/or features (e.g., top flange 126, bottom flange 125) as the dimensions and features of a rail 109 of a cable tray segment 110. Alternatively, the splice plate 120 can have one or more dimensions (other than the length 122) and/or features that are different than the dimensions and features of a rail 109.

The splice plate 120 also includes multiple apertures 123. The apertures 123 traverse the body 121 of the splice plate 120 and are positioned at both ends (the proximal end and the distal end) of the splice plate 120. Typically, as in this case, there are three apertures 123 at the proximal end of the splice plate 120 and another three apertures 123 at the distal end of the splice plate 120. The apertures 123 have a shape and size that is substantially similar to the shape and size of the apertures 113 of the rails 109. Also, the apertures 123 at each end of the splice plate 120 are oriented in such a way as to substantially align with the apertures 113 at the proximal end 117 of a rail 109 of a cable tray segment 110 and the apertures 113 at the distal end 118 of a rail 109 of an adjacent cable tray segment 110 when the proximal end 117 of the cable tray segment 110 and the distal end 118 of the adjacent cable tray segment 110 abut against each other.

When the apertures 123 of the splice plate 120 align with the apertures 113 at the proximal end 117 of a rail 109 of one cable tray segment 110 and the apertures 113 at the distal end 118 of a rail 109 of an adjacent cable tray segment 110, the bolts 124 can be inserted through and disposed within the apertures 123 and the apertures 113 to mechanically couple the splice plate 120 to the cable tray segment 110 and the adjacent cable tray segment 110. In this case, there are six bolts 124 for each splice plate 120, and two splice plates 120 are used to couple to adjoining cable tray segments 110, one for each rail 109 of each adjoining cable tray segment 110.

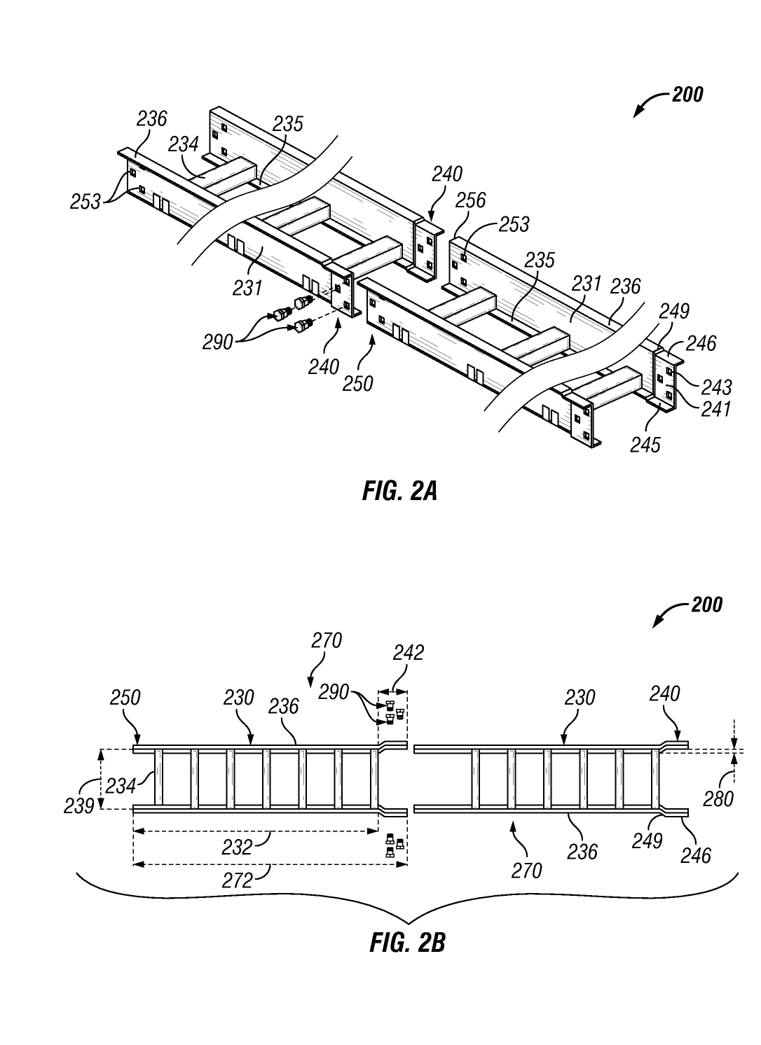

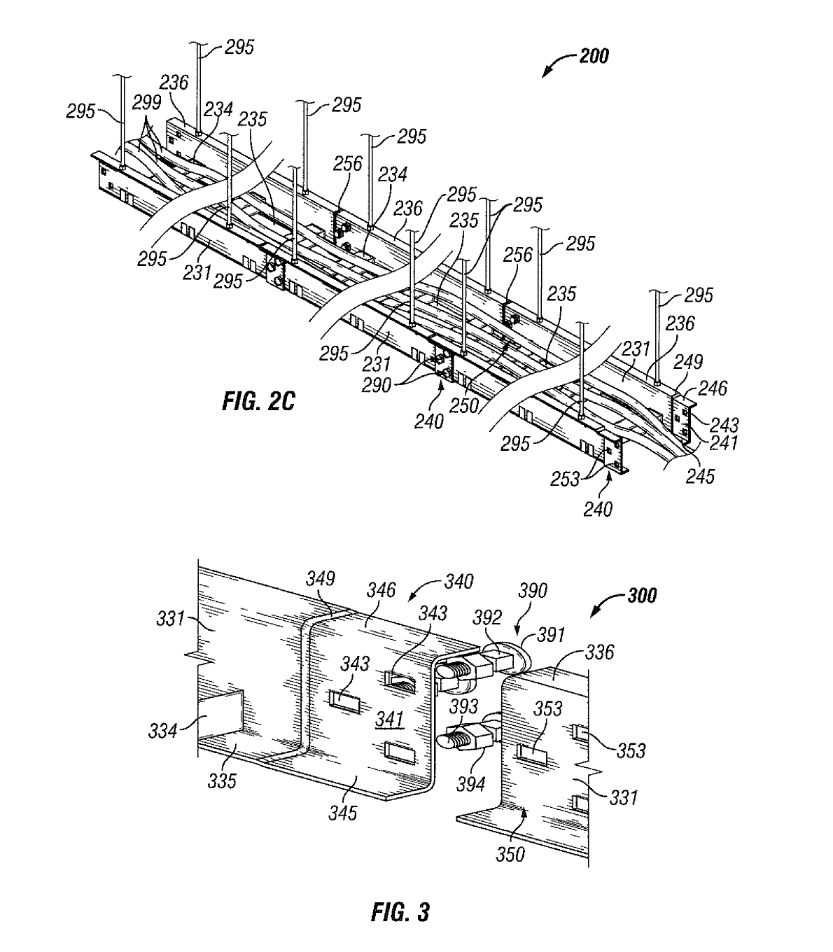

FIGS. 2A-2C show various views of cable tray system 200 that includes adjacent cable tray segments 270 in accordance with certain example embodiments. Specifically, FIG. 2A shows a top-side perspective view of the system 200, and FIG. 2B shows a top view of the system 200. FIG. 2C shows a cable tray system 201 in which three cable tray segments 270 are coupled to each other and have a number of electrical cables 299 disposed therein. In one or more embodiments, one or more of the components shown in FIGS. 2A-2C may be omitted, repeated, and/or substituted. Accordingly, embodiments of a cable tray system should not be considered limited to the specific arrangements of components shown in FIGS. 2A-2C.

Referring to FIGS. 1A-2C, the cable tray system 200 of FIGS. 2A and 2B can include two adjacent cable tray segments 270 that are substantially identical to each other. The system 200 can also include one or more fastening devices 290. Each cable tray segment 270 can include two rails 230 (also called side rails 230), where each rail 230 has a length 272 and is substantially parallel to the other rail 230 of the cable tray segment 270. A number of cable supports 234 (also called crossbars 234), each having a length 239, are disposed between and mechanically coupled to the two rails 230, giving each cable tray segment 270 a width that is substantially the same as the length 239 of the crossbars 234.

As shown in FIG. 2C, one or more electrical cables 299 (whether in conduit, in some other protective device, or on its own) can be laid upon the top of the crossbars 234. The crossbars 234 can be oriented substantially parallel to each other. A crossbar 234 can be positioned some distance (e.g., 6 inches, 8 inches, 10 inches, 36 inches) from an adjacent crossbar 234. The crossbars 234 can be used for load resistance, distributing the weight of the cables to some extent along the length and/or width of the cable tray segment 270. The spacing between adjacent crossbars 234 can affect the load resistance of the cables. FIG. 2C shows a number of cable tray supports 295 (e.g., chains, rods, straps) that are used to suspend the cable tray system 201 from a ceiling or other overhead structure.

As with the rails 109 of FIGS. 1A and 1B, the rails 230 of FIGS. 2A and 2B can include one or more of a number of optional features. For example, as shown in FIGS. 2A and 2B, a rail 230 can have a “Z” shape when viewed cross-sectionally along its length 272. Specifically, the rail 230 can have a body 231 that forms a substantially straight (flat) vertical line when viewed cross-sectionally along its length 272. Alternatively, some or all of the body 231 of the rail 230 can have one or more of a number of other shapes (e.g., curved, sawtoothed) when viewed cross-sectionally along its length 272. Each rail 230 of FIGS. 2A and 2B can also have a top flange 236 and a bottom flange 235, where the top flange 236 extends substantially perpendicularly outward from the top end of the body 231, and where the bottom flange 235 extends substantially perpendicularly inward from the bottom end of the body 231.

In certain example embodiments, each cable tray segment 270 can include a coupling portion 250 disposed at one end (e.g., the proximal end) of one or both rails 230, and a coupling portion 240 disposed at an opposite end (e.g., the distal end) of one or both rails 230. The coupling portion 250 can include one or more coupling features 253. In this case, the coupling features 253 are apertures that traverse the body 231 at the proximal end of the rail 230. Also, in this case, each coupling portion 250 has three coupling features 253 arranged in a particular orientation. The shape, size, and/or location of each coupling feature 253 can be substantially similar to a shape, size, and location of complementary coupling features disposed on an end (e.g., a distal end) of an adjacent cable tray segment to which the example cable tray segment 270 couples. The adjacent cable tray segment can also be an example cable tray segment 270. Alternatively, the adjacent cable tray segment can also be an existing cable tray segment.

In certain example embodiments, the coupling portion 240 protrudes from the rail 230. In such a case, the coupling portion 240 can have the same features as, or different features than, the rail 230. For example, as shown in FIGS. 2A and 2B, the coupling portion 240 can include a body 241 that forms a substantially straight (flat) vertical line when viewed cross-sectionally along its length 242. Alternatively, some or all of the body 241 of the coupling portion 240 can have one or more of a number of other shapes (e.g., curved, sawtoothed) when viewed cross-sectionally along its length 242. Each coupling portion 240 of FIGS. 2A and 2B can also include a top flange 246 and a bottom flange 245, where the top flange 246 extends substantially perpendicularly outward from the top end of the body 241, and where the bottom flange 245 extends substantially perpendicularly inward from the bottom end of the body 241. In other words, in this example, the coupling portion 240 can have a “Z” shape when viewed cross-sectionally along its length 242. The transition point 249 is the portion of the cable tray assembly 270 where the coupling portion 240 protrudes from the rail 230. Similarly, the coupling portion 240 of an example cable tray segment 270 can have the same features as, or different features than, the rail 230 of an adjacent cable tray segment 270 (or the proximal end of a rail of an existing cable tray segment).

The coupling portion 240 and the rail 230 can be formed from a single piece, as from a mold or by a machine that deforms the distal end of the rail 230 to achieve the coupling portion 240. Alternatively, the coupling portion 240 and the rail 230 can be separate pieces that are mechanically coupled to each other using one or more of a number of coupling methods, including but not limited to welding, fastening devices, compression fittings, slots, and tabs. In either case, the coupling portion 240 can be considered a part of, or a separate component from, the rail 230. In some cases, the overall length 272 of the rail 230 can include the length 242 of the coupling portion 240 and the length 232 of the rest of the rail 230.

When the coupling portion 240 protrudes from the rail 230, the coupling portion 240 can act similarly to a splice plate (as described above with respect to FIGS. 1A and 1B), which can have the effect of integrating a splice plate into the coupling portion 240. In other words, the length 242 of the coupling portion 240 can be substantially shorter than the length 232 of the rest of the rail 230. Otherwise, as shown in FIGS. 2A and 2B, the coupling portion 240 can have substantially the same dimensions (e.g., height, thickness) and/or features (e.g., top flange 246, bottom flange 245) as the dimensions and features of the rail 230 of the cable tray segment 270. Alternatively, the coupling portion 240 can have one or more dimensions (other than the length 242) and/or features that are different than the dimensions and features of the rail 230.

A coupling portion 240 can protrude from the rail 230 in one or more of a number of directions. As discussed above, each coupling portion 240 of each rail 230 protrudes outward in FIGS. 2A and 2B. In addition, or in the alternative, a coupling portion 240 can protrude in some other direction relative to the rail 230, including but not limited to inward, downward, and upward. For a cable tray segment 270 having multiple coupling portions 240, one coupling portion 240 can protrude from its rail 230 in the same or a different direction as the direction that another coupling portion 240 of the cable tray segment 270 protrudes from its respective rail 230.

Also, when the coupling portion 240 protrudes from the rail 230, the coupling portion 240 is located some distance 280 relative to the rail 230. For example, as shown in FIGS. 2A and 2B, the coupling portion 240 is displaced by distance 280 from the rail 230. In certain example embodiments, the distance 280 is substantially equal to the thickness of the body 231 of the rail 230 and/or the thickness of the body 241 of the coupling portion 240. Thus, when the proximal end of an adjacent cable tray segment (which can be an example cable tray segment 270 or an existing cable tray segment), having the coupling portion 250 or some equivalent thereof, abuts against the transition point 249 between the rail 230 and the coupling portion 240, the coupling portion 250 (or equivalent thereof) of the adjacent cable tray segment can also abut against the coupling portion 240, as shown in FIG. 2B.

The coupling portion 240 can include one or more coupling features 243. In this case, the coupling features 253 are apertures that traverse the body 241 at the proximal end of the coupling portion 240. Also, in this case, each coupling portion 240 has three coupling features 243 arranged in a particular orientation. The shape, size, and/or location of each coupling feature 243 can be substantially similar to a shape, size, and location of complementary coupling features disposed on an end (e.g., a distal end) of an adjacent cable tray segment to which the example cable tray segment 270 couples. The adjacent cable tray segment can also be an example cable tray segment 270. Alternatively, the adjacent cable tray segment can also be an existing cable tray segment.

In certain example embodiments, the shape, size, and location of the coupling features 243 of the coupling portion 240 are substantially the same as the shape, size, and location of the coupling features 253 of the coupling portion 250. In other words, when the proximal end of a cable tray segment 270 having the coupling portions 250 (or some other cable tray segment having an equivalent of the coupling portion) abuts against the transition point 249 of an adjacent cable tray segment 270, the coupling features 253 of the coupling portion 250 align with the coupling features 243 of the coupling portion 240.

When the coupling features 243 of the coupling portion 240 disposed on one rail 230 of a cable tray segment 270 align with the coupling features 253 of the coupling portion 250 disposed on a rail 230 of an adjacent cable tray segment 230 (or some equivalent coupling features of an existing cable tray segment), and when the coupling features 243 of the coupling portion 240 disposed on the other rail 230 of the cable tray segment 270 align with the coupling features 253 of the coupling portion 250 disposed on the other rail 230 of the adjacent cable tray segment 230 (or the equivalent coupling features of the existing cable tray segment), the fastening devices 290 can be inserted through and disposed within the apertures 243 and the apertures 253 to mechanically couple the cable tray segment 230 to the adjacent cable tray segment 230. In this case, there three fastening devices 290 for each pair of coupling portion 240 and coupling portion 250. In certain example embodiments, the fastening devices 290 are not used because the coupling features 243 and the coupling features 253 can be directly coupled to each other.

As stated above, example cable tray segments 270 can be used with existing cable tray segments currently known in the art, such as cable tray segment 110 described above with respect to FIGS. 1A and 1B. In such a case, the splice plate 120 is replaced by the coupling portion 240 of the example cable tray segment 270. Other sizing considerations are also made. For example, if the length 112 of an existing cable tray segment 110 is approximately 144 inches (12.0 feet), and if the length 122 of the splice plate 120 is approximately four inches, then the overall length 272 of the example cable tray segment 270 can be approximately 146 inches, where the length 242 of the coupling portion 250 is approximately two inches, and the length 232 of the rest of the cable tray segment 270 is approximately 144 inches.

The number of coupling features 243 of a coupling portion 240 can be the same as, or different than, the number of coupling features 253 of a coupling portion 250 to which the coupling portion 240 couples. In addition, or in the alternative, the number of coupling devices 290 can be the same as, or different than, the number of coupling features 243 and/or the number of coupling features 253 to which the coupling devices 290 couple.

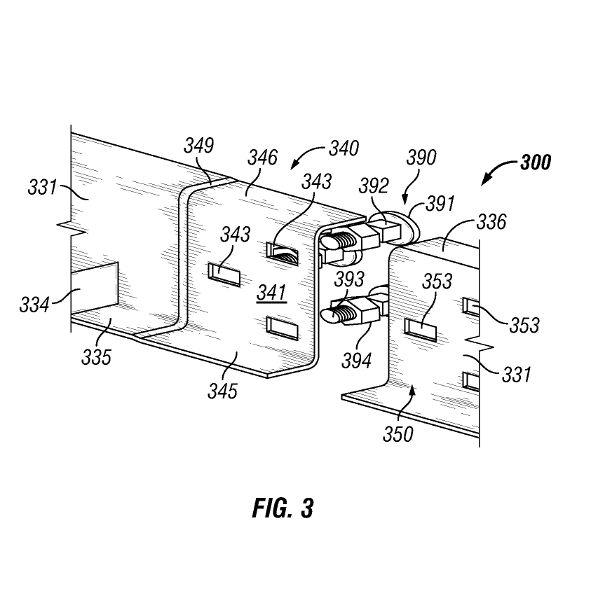

FIG. 3 shows a detailed view of a portion of a cable tray system 300 that includes coupling features of adjacent cable tray segments in accordance with certain example embodiments. Specifically, FIG. 3 shows how the coupling features 343 of the coupling portion 340 of an example cable tray segment 370 and/or the coupling features 353 of the coupling portion 350 of an adjacent cable tray segment 370 can be shaped and sized to increase reliability in coupling the fastening devices 390 to the coupling features 343 and the coupling features 353.

In this example, the coupling features 343 and the coupling features 353 are each rectangularly shaped (also called an aperture shape), having substantially the same height and width. The shape and size of the rectangle formed by the coupling features 343 and the coupling features 353 can be substantially the same as, or slightly larger than, the shape and size of a portion 392 of each fastening device 390. Specifically, the portion 392 of each fastening device 390, when viewed cross-sectionally along its length, forms the aperture shape (is rectangular). The portion 392 of the fastening device 390 is disposed within one of the coupling features 343 and an corresponding one of the coupling features 353. In such a case, the head 391 of the fastening device 390 can be rounded and have a continuously smooth surface, one or more coupling features. Examples of coupling features that can be removed from the head 391 can include, but are not limited to, a slot (or similar feature) disposed in the head 391 for a screwdriver, and a hex-head (or other shaped) configuration of its outer perimeter for a wrench or socket head.

In addition, the distal end 393 of the fastening device 390 can be positioned within the space of the cable tray (formed by the cable tray segments 370) in which one or more electrical cables (not shown) can be disposed. To prevent or reduce the chance of the distal end 393 of the fastening device 390 from puncturing, scratching, or otherwise damaging the electrical cable, a protective component 394 can cover some or all of the distal end 393 of the fastening device 390. The protective component 394 can have smooth, rounded, or other non-sharp edges, so that the protective component 394 has little or no possibility of damaging one or more of the electrical cables disposed within the cable tray, even over time and when the cable tray is subject to vibrations and other factors that can cause movement of the cable tray.

The protective component 394 can be a sleeve, a nut, a washer, and/or any other type of device. The protective component 394 can couple to the distal end 393 using one or more of a number of coupling methods, including but not limited to mating threads, fusion, epoxy, and clamps. The protective component 394 can be made of one or more of a number of materials, including but not limited to plastic, ceramic, rubber, and metal. In certain example embodiments, the orientation of the fastening device 390 is reversed, so that the head 391 is disposed against the inner-facing surface of the coupling portion 340 and/or the coupling portion 350. In such a case, because of the lack of coupling features disposed on the head 391 of the fastening device 390, the head 391 of each fastening device 390 has little or no possibility of damaging one or more of the electrical cables disposed within the cable tray

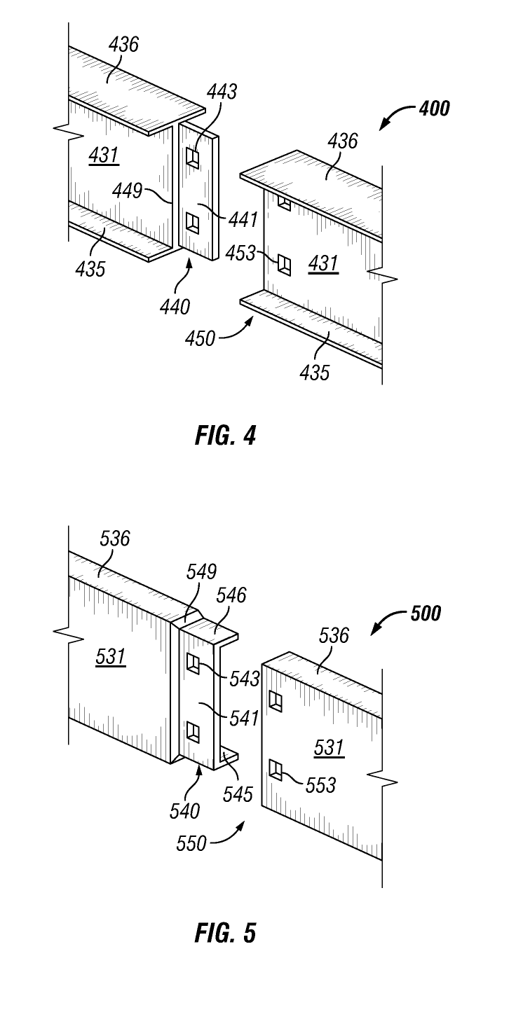

FIG. 4 shows a detailed view of a portion of a cable tray system 400 that includes coupling portions of adjacent cable tray segments in accordance with certain example embodiments. FIG. 5 shows a detailed view of a portion of a cable tray system 500 that includes alternative coupling portions of adjacent cable tray segments in accordance with certain example embodiments. In one or more embodiments, one or more of the components shown in FIGS. 4 and 5 may be omitted, repeated, and/or substituted. Accordingly, embodiments of a cable tray system should not be considered limited to the specific arrangements of components shown in FIGS. 4 and 5.

Referring to FIGS. 1-5, the system 400 of FIG. 4 shows how the coupling portion 440 of an example cable tray segment 470 can have a shape and size that is different than the shape and size of the rail 430 of the cable tray segment 470. Specifically, in this example, the rail 430 of the cable tray segment 470 forms an “I” shape when viewed cross-sectionally along its length 432, while the coupling portion 440 of the cable tray segment 470 forms a straight (flat) vertical line when viewed cross-sectionally along its length 442. The body 441 of the coupling portion 440 protrudes away from the body 431 of the rail 430 by a distance 480 that is approximately equal to the thickness of the body 431 of the rail 430.

The proximal end of the body 431 of the rail 430 of the adjacent cable tray segment 470 abuts against the transition point 449 disposed between the coupling portion 440 and the rail 430. In such a case, the coupling features 443 of the coupling portion 440 align with the coupling features 453 of the coupling portion 450. Here, there are two coupling features 443 and two coupling features 453, all having substantially the same shape and size.

FIG. 4 also shows that the coupling portion 440 of an example cable tray segment 470 can have a shape and size that is different than the shape and size of a proximal end (including the coupling portion 450) of a rail 430 of an adjacent cable tray segment 470. While the shape and size of the rail 430 of the adjacent cable tray segment 470 in FIG. 4 is substantially the same as the shape and size of the rail 430 of the cable tray segment 470, the shape and size of the rail 430 of the adjacent cable tray segment 470 in FIG. 4 can alternatively be different than the shape and size of the rail 430 of the cable tray segment 470.

FIG. 5 shows different features of the rail 530 and the coupling portion 540. Specifically, the rail 530 of the cable tray segment 570 forms a “C” shape when viewed cross-sectionally along its length 532. Similarly, the coupling portion 540 of the cable tray segment 570 forms a “C” shape when viewed cross-sectionally along its length 542. In such a case, the transition point 549 can extend beyond the body 531 of the rail 530 and the body 541 of the coupling portion 540. Specifically, the transition point 549 can also be disposed between the top flange 536 of the rail 530 and the top flange 546 of the coupling portion 540, as well as between the bottom flange 535 of the rail 530 and the bottom flange 545 of the coupling portion 540. Again, as with the system 400 of FIG. 4, there are two coupling features 543 and two coupling features 553, all having substantially the same shape and size.

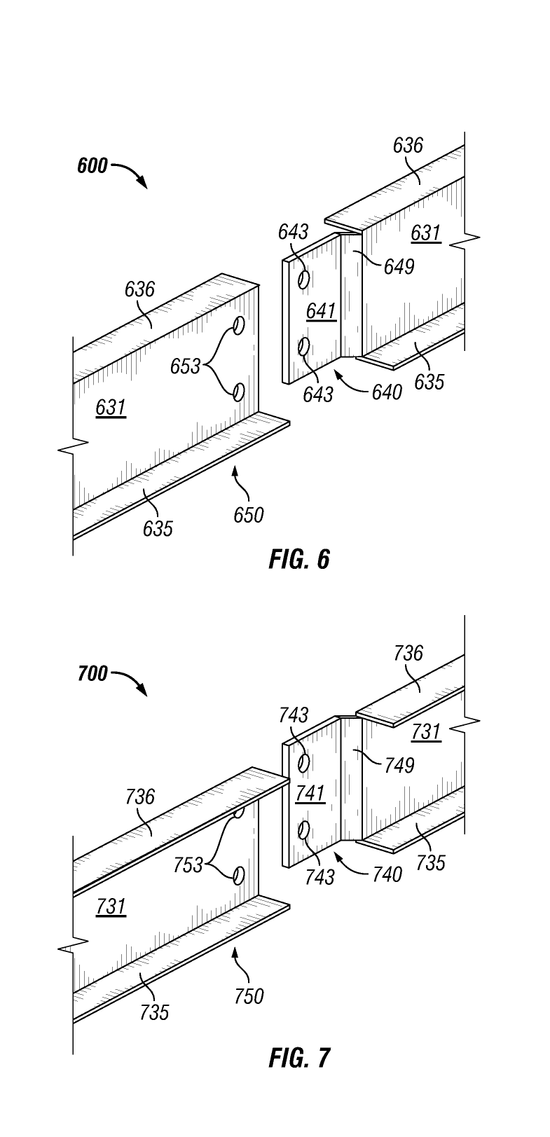

FIG. 6 shows different features of the rail 630 and the coupling portion 640. Specifically, the rail 630 of the cable tray segment 670 forms a “Z” shape when viewed cross-sectionally along its length 632. By contrast, the coupling portion 640 of the cable tray segment 670 forms a straight (flat) vertical line when viewed cross-sectionally along its length 642. In such a case, the transition point 649 can be disposed between the body 631 of the rail 630 and the body 641 of the coupling portion 640. In other words, the transition point 649 is not positioned adjacent to the top flange 636 of the rail 630 or the bottom flange 635 of the rail 630. Here, the coupling portion 640 extends away from the outer surface of the body 631 of the rail 630. In alternative embodiments, the coupling portion 640 can extend away from the inner surface of the body 631 of the rail 630. Again, as with the system 400 of FIG. 4, there are two coupling features 643 and two coupling features 653, all having substantially the same shape and size.

FIG. 7 shows different features of the rail 730 and the coupling portion 740. Specifically, the rail 730 of the cable tray segment 770 forms a “C” shape when viewed cross-sectionally along its length 732. By contrast, the coupling portion 740 of the cable tray segment 770 forms a straight (flat) vertical line when viewed cross-sectionally along its length 742. In such a case, the transition point 749 can be disposed between the body 731 of the rail 730 and the body 741 of the coupling portion 740. In other words, the transition point 749 is not positioned adjacent to the top flange 736 of the rail 730 or the bottom flange 735 of the rail 730. Here, the coupling portion 740 extends away from the outer surface of the body 731 of the rail 730. Again, as with the system 400 of FIG. 4, there are two coupling features 743 and two coupling features 753, all having substantially the same shape and size.

The example embodiments discussed herein provide for simplified retrofitting of certain portions of existing cable tray systems. Example embodiments can also allow for easy installation for new cable tray systems and existing cable tray systems. Cable tray systems using example embodiments can allow those cable tray systems to meet one or more of a number of cable tray standards, such as a NEMA classification for cable trays. Example embodiments requires fewer material, fewer parts (e.g., no splice plates, at least half the number of fastening devices). The design and reduction in parts of example embodiments can significantly reduce the amount of time, labor, cost, and material needed to install and/or repair a cable tray system.

In addition, the design of example cable tray segments creates a higher (e.g., 20%) mechanical resistance under load. In other words, the NEMA classification rating can be increased by using example embodiments. At the very least, even if under the same NEMA classification, example embodiments can hold a higher amount of weight within the cable tray.

Although the invention is described with reference to example embodiments, it should be appreciated by those skilled in the art that various modifications are well within the scope and spirit of this disclosure. Those skilled in the art will appreciate that the present invention is not limited to any specifically discussed application and that the embodiments described herein are illustrative and not restrictive. From the description of the example embodiments, equivalents of the elements shown therein will suggest themselves to those skilled in the art, and ways of constructing other embodiments of the present invention will suggest themselves to practitioners of the art. Therefore, the scope of the present invention is not limited herein.

1. A cable tray segment, comprising:
a first molecularly continuous side rail having a first length and comprising:
a first coupling portion forming one piece with the first molecularly continuous side rail and disposed at a first distal end of the first molecularly continuous side rail, wherein the first coupling portion protrudes from the first molecularly continuous side rail by a distance, and wherein the first coupling portion comprises at least one first coupling feature; and
a second coupling portion forming one piece with the first molecularly continuous side rail and disposed at a first proximal end of the first molecularly continuous side rail, wherein the second coupling portion comprises at least one first complementary coupling feature;
a second molecularly continuous side rail disposed substantially parallel to the first molecularly continuous side rail and having the first length, wherein the second molecularly continuous side rail comprises:
a third coupling portion forming one piece with the second molecularly continuous side rail and disposed at a second distal end of the second molecularly continuous side rail, wherein the third coupling portion protrudes from the second molecularly continuous side rail by the distance, and wherein the third coupling portion comprises at least one second coupling feature; and
a fourth coupling portion forming one piece with the molecularly continuous second side rail and disposed at a second proximal end of the second molecularly continuous side rail, wherein the fourth coupling portion comprises at least one second complementary coupling feature,
wherein the at least one first coupling feature is configured to mechanically couple to the first complementary coupling feature of a first other cable tray segment,
wherein the at least one first complementary coupling feature is configured to mechanically couple to the first coupling feature of a second other cable tray segment,
wherein the at least one second coupling feature is configured to directly mechanically couple to the second complementary coupling feature of the first other cable tray segment, and
wherein the at least one second complementary coupling feature is configured to directly mechanically couple to the second coupling feature of the second other cable tray segment.

2. The cable tray segment of claim 1, wherein the first coupling portion protrudes in an outward direction and is parallel to the length of the first molecularly continuous side rail, and wherein the distance is substantially equivalent to a thickness of the first molecularly continuous side rail.

3. The cable tray segment of claim 1, wherein the first molecularly continuous side rail, when viewed cross-sectionally along its length, forms a straight line.

4. The cable tray segment of claim 1, wherein the molecularly continuous first side rail, when viewed cross-sectionally along its length, forms a “C” shape.

5. The cable tray segment of claim 4, wherein the first coupling portion, when viewed cross-sectionally along its length, also forms the “C” shape.

6. The cable tray segment of claim 1, wherein the first molecularly continuous side rail, when viewed cross-sectionally along its length, forms an “I” shape.

7. The cable tray segment of claim 6, wherein the first coupling portion, when viewed cross-sectionally along its length, forms a straight line.

8. The cable tray segment of claim 1, wherein the first molecularly continuous side rail, when viewed cross-sectionally along its length, forms a “Z” shape.

9. The cable tray segment of claim 1, further comprising:
a plurality of crossbars disposed between and coupled to the first molecularly continuous side rail and the second molecularly continuous side rail.

10. A cable tray system, comprising:
a first cable tray segment comprising a first molecularly continuous side rail having a length and a second molecularly continuous side rail having the length, wherein the first molecularly continuous side rail and the second molecularly continuous side rail each comprises a first coupling portion that forms one piece with the first molecularly continuous side rail and the second molecularly continuous side rail and that is fixedly disposed at a first distal end, wherein each first coupling portion is recessed relative to the first molecularly continuous side rail and the second molecularly continuous side rail by a distance, wherein each first coupling portion comprises at least one first coupling feature;
a second cable tray segment comprising a third molecularly continuous side rail having the length and a fourth molecularly continuous side rail having the length, wherein the third molecularly continuous side rail and the fourth molecularly continuous side rail each comprises a second coupling portion that forms one piece with the third molecularly continuous side rail and the fourth molecularly continuous side rail and that is fixedly disposed at a second proximal end, wherein each second coupling portion comprises at least one first complementary coupling feature; and
at least one crossbar disposed between and coupled to the first molecularly continuous side rail and the second molecularly continuous side rail,
wherein the at least one first coupling feature couples to the at least one first complementary coupling feature.

11. The cable tray system of claim 10, further comprising:
a third cable tray segment, comprising a fifth molecularly continuous side rail having the length and a sixth molecularly continuous side rail having the length, wherein the fifth molecularly continuous side rail and the sixth molecularly continuous side rail each comprise a third coupling portion that forms one piece with the fifth molecularly continuous side rail and the sixth molecularly continuous side rail and that is fixedly disposed at a second distal end, wherein each of the third coupling portions is recessed relative to the fifth molecularly continuous side rail and the sixth molecularly continuous side rail by the distance, wherein each third coupling portion comprises the at least one first coupling feature,
wherein the first cable tray segment further comprises the at least one first complementary coupling feature disposed on a fourth coupling portion at a first proximal end of the first molecularly continuous side rail and the second molecularly continuous side rail, and
wherein the at least one first coupling feature of the third cable tray segment couples to the at least one first complementary coupling feature of the first cable tray segment.

12. The cable tray system of claim 10, further comprising:
at least one fastening device coupled to the at least one first coupling feature of the first coupling portion of the first cable tray segment and the at least one first complementary coupling feature of the second coupling portion of the second cable tray segment.

13. The cable tray system of claim 12, wherein the at least one first coupling feature of the first cable tray segment and the at least one first complementary coupling feature of the second cable tray segment each has an aperture shape, wherein the at least one fastening device comprises a portion that, when viewed cross-sectionally along its length, forms the aperture shape, wherein the portion of the at least one fastening device is disposed within the at least one first coupling feature of the first cable tray segment and the at least one first complementary coupling feature of the second cable tray segment.

14. The cable tray system of claim 12, wherein the aperture shape is a rectangle.

15. The cable tray system of claim 10, wherein the at least one first coupling feature of the first cable tray segment and the at least one first complementary coupling feature of the second cable tray segment align with each other when the second coupling portion disposed at the second proximal end of the third molecularly continuous side rail and the fourth molecularly continuous side rail of the second cable tray abuts against a transition point of the first cable tray segment, wherein the transition point is where each of the first coupling portions is recessed relative to the first molecularly continuous side rail and the second molecularly continuous side rail of the first cable tray segment.

16. The cable tray system of claim 10, wherein the first molecularly continuous side rail, when viewed cross-sectionally along its length, forms a first shape that is substantially the same as a second shape formed by the first coupling portion when the first coupling portion is viewed cross-sectionally along its length.

17. The cable tray system of claim 10, wherein the first molecularly continuous side rail, when viewed cross-sectionally along its length, forms a first shape that is different than a second shape formed by the first coupling portion when the first coupling portion is viewed cross-sectionally along its length.

18. The cable tray system of claim 10, wherein the first cable tray segment replaces an existing cable tray segment, and wherein the second cable tray segment and the existing cable tray segment are part of an existing cable tray system.

19. A cable system, comprising:
a first cable tray segment comprising a first molecularly continuous side rail having a length and a second molecularly continuous side rail having the length, wherein the first molecularly continuous side rail and the second molecularly continuous side rail each comprises a first coupling portion that forms one piece with the first molecularly continuous side rail and the second molecularly continuous side rail and that is fixedly disposed at a first distal end, wherein each of the first coupling portions protrudes from the first molecularly continuous side rail and the second molecularly continuous side rail by a distance, wherein each first coupling portion comprises at least one first coupling feature;
a second cable tray segment comprising a third molecularly continuous side rail having the length and a fourth molecularly continuous side rail having the length, wherein the third molecularly continuous side rail and the fourth molecularly continuous side rail each comprises a second coupling portion that forms one piece with the third molecularly continuous side rail and the fourth molecularly continuous side rail and that is fixedly disposed at a second proximal end, wherein each second coupling portion comprises at least one first complementary coupling feature;
at least one fastening device directly coupled to the at least one first coupling feature of the first cable tray segment and the at least one first complementary coupling feature of the second cable tray segment;
a plurality of crossbars disposed between and coupled to the first molecularly continuous side rail and the second molecularly continuous side rail; and
at least one cable disposed on the plurality of crossbars.

20. The cable system of claim 19, further comprising:
a plurality of cable tray supports, wherein the at least one cable weighs at least 50 pounds per foot when the plurality of cable tray supports for the first cable tray segment are spaced 8 feet apart from each other.
